(19) United States
(12) Patent Application Publication
(10) Pub. No.: US 2007/0098436 A1
(43) Pub. Date: May 3, 2007

(54) Image forming apparatus

(75) Inventor: Takeshi Arakawa, Osaka (JP)

Correspondence Address: RABIN & Berdo, PC, 1101 14TH STREET, NW, SUITE 500, WASHINGTON, DC, 20005, US

(73) Assignee: KYOCERA MITA CORPORATION

(21) Appl. No.: 11/582,434

(22) Filed: Oct. 18, 2006

(30) Foreign Application Priority Data
Oct. 31, 2005 (JP) 2005-317032

(51) Int. Cl. G03G 15/01; G03G 15/08

(52) U.S. Cl. 399/103; 399/227; 399/252

(57) ABSTRACT

The present invention provides an image forming apparatus which effectively prevents back flow of unused toner and contamination of the inside of an image forming apparatus due to the back flow while allowing for improvement in transfer efficiency and image quality and size reduction of the image forming apparatus. The image forming apparatus includes: a developing device including a developing roller, a supply roller, a casing housing the developing roller and the supply-roller, and a lower seal disposed along a lower edge of an opening of the casing; and a photosensitive drum disposed in opposed relation to the developing roller. The lower seal is inclined downward from the inside of the casing toward an open side in a developing process. A nonmagnetic toner to be herein used includes toner particles having a sphericity not less than 0.98 and an additive adhering to surfaces of the toner particles, and has a loose bulk density AD not less than 0.3g/cm³ and a compaction degree not less than 0.30 and less than 0.36.

### BACKGROUND OF THE INVENTION

1. Field of the Invention

The present invention relates to an image forming apparatus employing a nonmagnetic single-component toner.

2. Description of the Related Art

In developing means of an image forming apparatus employing a single-component developer system, toner triboelectrically charged at a nip defined between a developing roller and a supply roller is applied onto a surface of the developing roller to form a toner layer, which is in turn transferred onto a surface of an image carrier from the developing roller. Thus, an electrostatic latent image on the surface of the image carrier is developed into a toner image.

A part of the toner once carried on the surface of the developing roller but unused for the development adheres to the surface of the developing roller and, in this state, passes through a contact between the developing roller and a lower seal disposed on a lower edge of an opening of a casing of the developing device. Thus, the unused toner is fed back into the casing, and moved within the casing to be used again for the development.

Where the toner has a lower fluidity, however, the toner is unlikely to be smoothly moved within the casing after passing through the contact between the developing roller and the lower seal. If the unused toner fed back into the casing is not smoothly moved within the casing, the toner stagnates to be compacted in a region surrounded by the developing roller, the supply roller and the nip defined between the developing roller and the supply roller. If the compaction degree of the toner is increased, stable formation of the toner layer on the surface of the developing roller is impossible, and the fluidity of the toner is further reduced.

If the stagnation of the toner in the aforesaid region is aggravated, a part of the unused toner otherwise passing through the contact between the developing roller and the lower seal is forced to flow back by the stagnant toner, whereby the unused toner is spilled from the casing to contaminate the inside of the image forming apparatus.

Therefore, various attempts including improvement of an external additive to be added to the toner are conventionally made to improve the fluidity of the toner.

On the other hand, the use of a toner having higher sphericity has recently been proposed for improvement in transfer efficiency and improvement in image quality (Japanese Unexamined Patent Publication No. 2004-212540).

The highly spherical toner is more liable to be densely compacted, whereby the stagnation of the toner in the aforesaid region is further aggravated due to reduction of the fluidity caused by the compaction.

With a recent demand for size reduction of the image forming apparatus, it is difficult to provide a space below the developing means and the image carrying means (e.g., a photosensitive drum) in the image forming apparatus. Therefore, the developing means tends to be disposed-above the image carrying means in the image forming apparatus. With positional limitation on the developing device, there is no other choice but to incline the opening of the casing of the developing device downward from the inside of the casing toward an open side.

In this case, the toner is liable to be spilled from the casing depending on the position and orientation of the lower seal, so that the contamination of the inside of the image forming apparatus is more liable to occur.

### SUMMARY OF THE INVENTION

It is an object of the present invention to provide an image forming apparatus which effectively prevents the back flow of the unused toner and the contamination of the inside of the image forming apparatus due to the back flow, while allowing for the improvement in transfer efficiency, the improvement in image quality and the size reduction of the image forming apparatus.

To achieve the aforesaid object, the inventive image forming apparatus comprises developing means which includes a casing, a nonmagnetic toner filled in the casing, a developing roller disposed in an opening of the casing and supported by a first shaft so as to be rotated in one direction in a developing process, a supply roller disposed within the casing in contact with the developing roller and supported by a second shaft so as to be rotated in a direction opposite to the direction of the rotation of the developing roller at a nip defined between the developing roller and the supply roller in the developing process, a toner layer thickness regulating member disposed downstream of the nip with respect to the direction of the rotation of the developing roller rotated in the developing process and a lower seal disposed along a lower edge of the opening of the casing, and image carrying means disposed in opposed relation to the developing roller of the developing means, wherein the lower seal is inclined downward from an inside of the casing toward an end of an opening in the developing process, wherein the nonmagnetic toner comprises toner particles having a sphericity not less than 0.98, and an additive adhering to surfaces of the toner particles, and has a bulk density AD not less than 0.3 g/cm³ as determined after the nonmagnetic toner is allowed to freely fall to fill a container, and a compaction degree not less than 0.30 and less than 0.36 as calculated from the following expression (i):
Compaction degree=(PD−AD)/PD (i)
wherein PD is a bulk density (g/cm³) of the nonmagnetic toner determined after the container filled with the nonmagnetic toner allowed to freely fall is tapped at a frequency of 1 Hz with an amplitude of 18 mm for 3 minutes.

In the inventive image forming apparatus, the developing means may include, for example, a plurality of the developing means, and the image forming apparatus may further comprise a generally cylindrical rotary developing unit disposed in opposed relation to the image carrying means and supported by a third shaft, wherein the plurality of developing means are mounted around the rotary developing unit so that the developing rollers of the developing means are each brought into opposed relation to the image carrying means when the rotary developing unit is rotated about its axis.

In the inventive image forming apparatus, the lower seal disposed along the lower edge of the opening of the casing of the developing device is inclined downward from the inside of the casing toward the end of the opening, but yet the spillage of the toner from the casing and the contamination of the inside of the image forming apparatus due to the spillage of the toner can be suppressed.

The nonmagnetic toner to be used in the inventive image forming apparatus comprises the highly spherical toner particles, but the apparent density and the compaction degree of the toner are adjusted in the aforesaid proper ranges. This makes it possible to suppress the stagnation of an unused portion of the toner in a region surrounded by the developing roller, the supply roller and the nip defined between the developing roller and the supply roller. Further, it is also possible to suppress compaction deformation of the toner particles and back flow of the toner from the developing roller which may otherwise occur due to the stagnation of the unused toner.

Therefore, the inventive image forming apparatus effectively prevents the back flow of the unused toner and the contamination of the inside of the image forming apparatus due to the back flow, while allowing for the improvement in transfer efficiency, the improvement in image quality and the size reduction of the image forming apparatus.

### BRIEF DESCRIPTION OF THE DRAWINGS

FIG. 1 is a schematic diagram illustrating the construction of an image forming apparatus according to one embodiment of the present invention; and

FIG. 2 is a schematic diagram illustrating the construction of an image forming apparatus according to another embodiment of the present invention.

### DESCRIPTION OF PREFERRED EMBODIMENTS

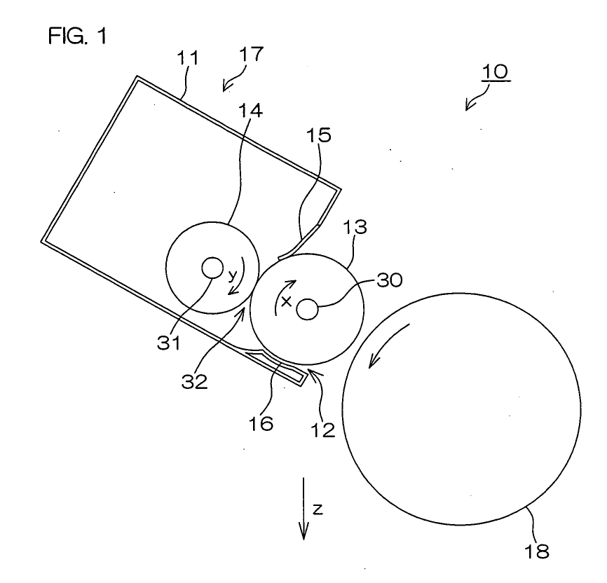

An image forming apparatus 10 shown in FIG. 1 includes a developing device (developing means) 17 including a casing 11, a nonmagnetic toner (not shown) filled in the casing 11, a developing roller 13 disposed in an opening 12 of the casing, a supply roller 14 disposed in the casing 11 in contact with the developing roller 13, a regulation blade (toner layer thickness regulating member) 15 provided in contact with a surface of the developing roller 13 and a lower seal 16 disposed along a lower edge of the opening 12 of the casing 11, and a photosensitive drum (image carrying means) 18 disposed in opposed relation to the developing roller 13 of the developing device 17.

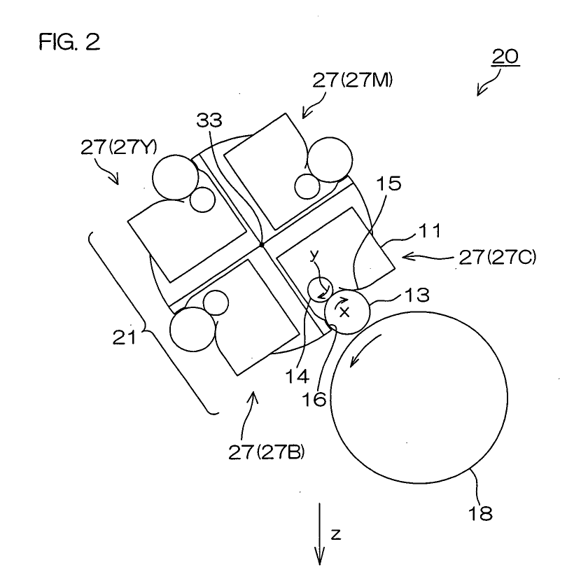

On the other hand, an image forming apparatus 20 shown in FIG. 2 includes a rotary developing unit 21 including a plurality of developing devices 27 (27C, 27M, 27Y, 27B), and a photosensitive drum 18 disposed in opposed relation to a developing roller 13 of one of the developing devices 27 (e.g., the developing device 27C in FIG. 2) actually participating in a developing process. The respective developing units 27 are mounted around the rotary developing unit 21, and include a casing 11, a nonmagnetic toner (not shown) filled in the casing 11, a developing roller 13 disposed in an opening 12 of the casing 11, a supply roller 14 disposed within the casing 11 in contact with the developing roller 13, a regulation blade 15 provided in contact with a surface of the developing roller 13 and a lower seal 16 disposed along a lower edge of the opening 12 of the casing 11.

The nonmagnetic toner contains toner particles having a sphericity not less than 0.98, and an additive adhering to surfaces of the toner particles. The nonmagnetic toner has a bulk density not less than 0.3 g/cm³ and a compaction degree not less than 0.30 and less than 0.36 as calculated from the aforesaid expression (i).

The toner particles may be prepared by any of various preparation methods, for example, including a polymerization method (e.g., a suspension polymerization method or an emulsion polymerization/agglomeration method) and a pulverization method, but is particularly preferably prepared by the polymerization method. Where the toner particles are prepared by the polymerization method, the sphericity of the toner particles can be easily controlled to not less than 0.980.

The toner particles prepared by the polymerization method are particles of a binder resin which are prepared by polymerization in an aqueous medium, and contain a colorant, a wax, a charge controlling agent and the like.

The binder resin is not particularly limited, but any of resins conventionally used for preparation of nonmagnetic toner particles may be used as the binder resin. Specific examples of the binder resin include thermoplastic resins such as styrene resins (e.g., polystyrene, styrene copolymers and the like), acryl resins (e.g., polymethyl methacrylate and the like), polyolefin resins (e.g., polyethylene, polypropylene, ethylene-α-olefin copolymers and the like), vinyl chloride resins (e.g., polyvinyl chloride, polyvinylidene chlorideandthe like), polyester resins (e.g., polyethylene terephthalate, polybutylene terephthalate and the like), polyamide resins, polyurethane resins, polyvinyl alcohol resins and vinyl ether resins. Among these resins, the styrene resins are preferred, and the polystyrene copolymers are particularly preferred.

The styrene copolymers are copolymers consisting essentially of a styrene monomer. Examples of the styrene monomer include styrene, o-methylstyrene and p-methylstyrene, among which styrene is preferred.

Examples of a second monomer to be copolymerized with the styrene monomer include p-chlorostyrene, vinylnaphthalene, alkenes (monoolefins) such as ethylene, propylene, butylene and isobutylene, vinyl halides such as vinyl chloride, vinyl bromide and vinyl fluoride, vinyl esters such as vinyl acetate, vinyl propionate, vinyl butyrate and vinyl benzoate, (meth) acrylates such as methyl acrylate, ethyl acrylate, n-butyl acrylate, isobutyl acrylate, dodecyl acrylate, n-octyl acrylate, 2-chloroethyl acrylate, phenyl acrylate, methyl α-chloroacrylate, methyl methacrylate, ethyl methacrylate, butyl methacrylate, 2-ethylhexyl methacrylate and n-octyl methacrylate, nitrogen-containing acrylic acid derivatives such as acrylonitrile, methacrylonitrile and acrylamide, vinyl ethers such as vinyl methyl ether and vinyl isobutyl ether, vinyl ketones such as vinyl methyl ketone, vinyl ethyl ketone and methyl isopropenyl ketone, and nitrogen-containing vinyl compounds such as N-vinylpyrrole, N-vinylcarbazole, N-vinylindole and N-vinylpyrrolidene. One of these second monomers may be copolymerized with the styrene monomer, or two or more of these second monomers may be copolymerized with the styrene monomer. Among the aforesaid second monomers, the (meth) acrylates are preferred, and (meth) acrylates of aliphatic alcohols having a carbon number of 1 to 12 (further preferably a carbon number of 3 to 8) are particularly preferred. Further, 2-ethylhexyl methacrylate is more preferable.

Examples of the colorant include inorganic pigments, organic pigments and synthetic dyes. These colorants may be used either alone, or one or more of the inorganic and/or organic pigments may be used in combination with one or more of the dyes.

Examples of the inorganic pigments include metal powder pigments (e.g., iron powder, copper powder and the like), metal oxide pigments (e.g., magnetite, ferrite, red oxide and the like), and carbon pigments (e.g., carbon black, furnace black and the like).

Examples of the organic pigments include azo pigments (e.g., benzidine yellow, benzidine orange and the like), acidic dye pigments and basic dye pigments (e.g., pigments prepared by precipitating-dyes such as quinoline yellow, acid green and alkali blue with a precipitating agent, and pigments prepared by precipitating dyes such as rhodamine, magenta and malachite green with tannic acid or phosphomolybdicacid), mordant dye pigments (e.g., metal salts such as of hydroxyanthraquinones), phthalocyanine pigments (e.g., phthalocyanine blue, sulfonated copper phthalocyanine and the like), and quinacridone pigments and dioxane pigments (e.g., quinacridone red, quinacridone violet and the like).

Examples of the synthetic dyes include aniline black, azo dyes, naphthoquinone dyes, indigo dyes, nigrosine dyes, phthalocyanine dyes, polymethine dyes, triarylmethane dyes and diarylmethane dyes.

Where the toner to be used includes a magenta toner, a yellow toner, a cyan toner and a black toner, the following colorants are preferably used. Exemplary colorants for the magenta toner include Color index (C.I.) Pigment Red 81, C.I. Pigment Red 122, C.I. Pigment Red 57, C.I. Pigment Red 49, C.I. Solvent Red 49, C.I. Solvent Red 19, C.I. Solvent Red 52, C.I. Basic Red 10 and C.I. Disperse Red 15. Exemplary colorants for the yellow toner include nitro pigments such as Naphthol Yellow S, azo pigments such as Hansa Yellow 5G, Hansa Yellow 3G, Hansa Yellow G, Benzidine Yellow G and Valcan Fast Yellow 5G, inorganic pigments such as yellow iron oxide and yellow ocher, C.I. Pigment Yellow 12, C.I. Pigment Yellow 180, C.I. Solvent Yellow 2, C.I. Solvent Yellow 6, C.I. Solvent Yellow 14, C.I. Solvent Yellow 15, C.I. Solvent Yellow 16, C.I. Solvent Yellow 19 and C.I. Solvent Yellow 21. Exemplary pigments for the cyan toner include C.I. Pigment Blue 15, C.I. Pigment Blue 15-1, C.I. Pigment Blue 16, C.I. Solvent Blue 55, C.I. Solvent Blue 70, C.I. Direct Blue 86 and C.I. Direct Blue 25. Exemplary pigments for the black toner include carbon blacks such as acetylene black, lampblack and aniline black. Ferromagnetic metal particles (e.g., magnetic powder such as of iron, cobalt and nickel) such as ferrite and magnetite may be added as the black colorant.

The amount of the colorant to be blended is preferably 1 to 50 parts by weight, more preferably 1 to 20 parts by weight, based on 100 parts by weight of the binder resin.

The wax is blended for improving the fixability of the nonmagnetic toner and efficiently preventing offset and image smearing. Examples of the wax include polyethylene waxes, polypropylene waxes, Teflon (registered trade name) waxes, Fischer-Tropschwaxes, paraffinwaxes, carnaubawaxes, ester waxes, montan waxes and rice waxes. These waxes may be used either alone or in combination.

The amount of the wax to be blended is preferably 1 to 10 parts by weight based on 100 parts by weight of the binder resin. If the blend amount of the wax is less than the aforesaid range, it is impossible to efficiently prevent the offset and the image smearing. On the other hand, if the blend amount of the wax is greater than the aforesaid range, the resulting nonmagnetic toner particles are liable to be fusion-bonded to each other, thereby having reduced storage stability.

The charge controlling agent is blended for improving the charge level and the charge build-up characteristic (an index indicating the capability of charging the toner to a predetermined charge level in a short period) of the nonmagnetic toner and improving the durability, the stability and like characteristics of the nonmagnetic toner. Where the nonmagnetic toner is positively charged, a positively-chargeable charge controlling agent is blended. Where the nonmagnetic toner is negatively charged, a negatively-chargeable charge controlling agent is blended.

Examples of the positively-chargeable charge controlling agent include nitrogen-containing heterocyclic compounds such as quaternary ammonium compounds (e.g., quaternary ammonium salts such as benzylmethyl hexyldecyl ammonium and decyltrimethyl ammonium chloride), pyridazine, pyrimidine, pyrazine, oxazine derivatives (e.g., 1,2-, 1,3- and 1,4-oxazines and the like), thiazine derivatives (e.g., 1,2-, 1,3- and 1,4-thiazines and the like), triazine derivatives (1,2,3-, 1,2,4- and 1,3,5-triazines and the like), oxadiazine derivatives (e.g., 2H-1,2,3-, 4H-1,2,4-, 6H-1,3,4-oxadiazines and the like), thiadiazine derivatives (e.g., 2H-1,2,3-, 4H-1,2,4-, 6H-1,3,4-thiadiazines and the like), tetrazine derivatives (e.g., 1,2,3,4-, 1,2,4,5- and 1,2,3,5-tetrazines and the like), oxatriazine derivatives (1,2,4,6-, 1,3,4,5-oxatriazines and the like), phthalazines, quinazolines and quinoxalines, direct dyes of azine compounds such as Azine Fast Red FC, Azine Fast Red 12BK, Azine Violet BO, Azine Brown 3G, Azine Light Brown GR, Azine Dark Green BH/C, Azine Deep Black EW and Azine Deep Black 3RL, nigrosine compounds such as nigrosine, nigrosine salts and nigrosine derivatives, acidic dyes of nigrosine compounds such as Nigrosine BK, Nigrosine NB and Nigrosine Z, metal salts such as of naphthenic acid and higher fatty acids, alkoxylated amines, and alkylamides. These positively-chargeable charge controlling agents may be used either alone or in combination. Among the positively-chargeable charge controlling agents, the quaternary ammonium compounds are preferred for providing a rapid charge build-up characteristic.

Other examples of the positively-chargeable charge controlling agent include resins and oligomers each having a quaternary ammonium salt, a carboxylate or a carboxyl group as a functional group. More specific examples of such positively-chargeable charge-controlling agents include-styrene resins each having a quaternary ammonium salt, acryl resins each having a quaternary ammonium salt, styrene-acryl resins each having a quaternary ammonium salt, polyester resins each having a quaternary ammonium salt, styrene resins each having a carboxylate, acryl resins each having a carboxylate, styrene-acryl resins each having a carboxylate, polyester resins each having a carboxylate, polystyrene resins each having a carboxyl group, acryl resins each having a carboxyl group, styrene-acryl resins each having a carboxyl group, and polyester resins each having a carboxyl group.

The quaternary ammonium salt is, for example, a unit derived from a dialkylaminoalkyl (meth) acrylate through a quaternary ammonium preparing process. Preferred examples of the dialkylaminoalkyl (meth)acrylate for the derivation include di-lower alkylaminoethyl (meth)acrylates such as dimethylaminoethyl (meth)acrylate, diethylaminoethyl (meth) acrylate, dipropylaminoethyl (meth) acrylate and dibutylaminoethyl (meth) acrylate, and dimethyl methacrylamide and dimethylaminopropyl methacrylamide. A hydroxyl-containing polymerizable monomer such as hydroxyethyl (meth) acrylate, hydroxypropyl (meth) acrylate, 2-hydroxybutyl (meth) acrylate or N-methylol (meth) acrylamide may also be used for the polymerization.

Examples of the negatively-chargeable charge controlling agent include organic metal complexes and chelate compounds. More specific examples of the negatively-chargeable charge controlling agent include acetylacetone-metal complexes such as acetylacetonatoaluminum and acetylacetonatoiron (II) and their salts, and salicylic acid-metal complexes such as chromium 3,5-di-tert-butylsalicylate and their salts.

The amount of the charge controlling agent to be blended is preferably 1 to 15 parts by weight, more preferably 1.5 to 8 parts by weight, further more preferably 2 to 7 parts by weight, based on 100 parts by weight of the resin binder. If the blend amount of the charge controlling agent is too small, it is difficult to stably charge the resulting nonmagnetic toner. If such a nonmagnetic toner is used for the image formation, reduction of the image density and deterioration of the stability of the image density will result. In addition, the charge controlling agent is liable to be insufficiently dispersed, thereby resulting in so-called fogging and remarkable contamination of the photosensitive body. On the other hand, if the blend amount of the charge controlling agent is too great, the environmental resistance will be reduced and, particularly in a high temperature and high humidity environment, insufficient charging and defective image formation will be remarkable. Further, the contamination of the photosensitive body is liable to occur.

In the suspension polymerization method for the preparation of the toner particles, the monomer for the binder resin, the colorant, the wax, the charge controlling agent and a crosslinking agent are dispersed in an aqueous medium (e.g., water or a solvent mixture containing water and a solvent miscible with water), and a suspension stabilizer and the like are optionally added to the aqueous medium. Then, the resulting aqueous dispersion is stirred, so that the binder resin monomer and the other components are disintegrated into particles having proper particle diameters in the aqueous medium. Thereafter, a polymerization initiator is added to the aqueous dispersion, and the resulting dispersion is heated to provide the toner particles.

Any of the binder resins described above may be used for the suspension polymerization. Among these binder resins, the styrene resins are preferred, and the styrene copolymers are particularly preferred.

Any of the styrene monomers described above may be used as a monomer for the styrene copolymer, and any of the second monomers described above may be used as a monomer to be copolymerized with the styrene monomer.

Any of the colorants, the waxes and the charge controlling agents described above may be used for the suspension polymerization, and the colorant, the wax and the charge controlling agent may be blended in the aforesaid amounts.

Examples of the crosslinking agent include aromatic divinyl compounds such as divinylbenzene and divinylnaphthalene, carboxylates such as ethylene glycol diacrylate, ethylene glycol dimethacrylate and 1,3-butanediol dimethacrylate, and divinyl compounds such as divinylaniline, divinyl ether, divinyl sulfide and divinyl sulfone, which may be used either alone or in combination. The amount of the crosslinking agent to be added is preferably 0.1 to 10 parts by weight based on 100 parts by weight of the binder resin monomer.

Examples of the polymerization initiator include azo and diazo polymerization initiators such as 2,2-azobis(2,4-dimethylvaleronitrile), 2,2′-azobis(2,4-dimethylvaleronitrile), 2,2′-azobisisobutylonitrile, 1,1′-azobis(cyclohexane-1-carbonitrile), 2,2′-azobis-4-methoxy-2,4-dimethylvaleronitrile and azobisisobutyronitrile, and peroxide polymerization initiators such as benzoyl peroxide, methylethyl ketone peroxide, diisopropyl peroxycarbonate, cumene hydroperoxide, 2,4-dichlorobenzoyl peroxide and lauroyl peroxide, which may be used either alone or in combination. The amount of the polymerization initiator to be added is preferably 0.5 to 20 parts by weight based on 100 parts by weight of the binder resin monomer.

The suspension stabilizer is preferably a compound (neutral or alkaline in water) which can be easily removed by acid washing after the polymerization. Examples of the suspension stabilizer include inorganic compounds such as tricalcium phosphate, magnesium phosphate, aluminum phosphate, zinc phosphate, calcium carbonate and magnesium carbonate, and organic compounds such as polyvinyl alcohol, gelatin, methyl cellulose, methylhydroxypropyl cellulose and ethyl cellulose, and their sodium salts. The amount of the suspension stabilizer to be added is preferably 0.2 to 10 parts by weight based on 100 parts by weight of the binder resin monomer.

For disintegration of the suspension stabilizer, a surface active agent may be added in a proportion of 0.001 to 0.5 parts by weight based on 100 parts by weight of the binder resin monomer. Examples of the surface active agent include sodium dodecylbenzenesulfonate, sodium oleate, sodium laurate, potassium stearate and calcium oleate.

The amount of the aqueous medium for the suspension polymerizationis preferably 300 to 1000 parts by weight based on 100 parts by weight of the binder resin monomer.

The size of the toner particles prepared by the suspension polymerization is controlled by controlling the speed and period of the stirring of the aqueous dispersion containing the aforesaid components. The stirring speed and the stirring period in the polymerization are not particularly limited. For example, the aqueous dispersion is stirred at 2000 to 10000 rpm for 5 minutes to 1 hour. Then, the polymerization is allowed to proceed at 50 to 90° C. for 2 to 20 hours, while the aqueous dispersion is stirred so as to sustain the particles and prevent precipitation of the particles. Thus, a dispersion of the toner particles is prepared. The polymerization is preferably allowed to proceed in a nitrogen atmosphere.

The toner particles thus prepared preferably have a glass transition temperature (Tg) of 50 to 75° C., more preferably 60 to 70° C. The stirring speed may be properly controlled within the aforesaid range so as to allow the toner particles to have a sphericity not less than 0.980.

In the emulsion polymerization/agglomeration method for the preparation of the toner particles, a resin dispersion prepared by emulsion polymerization is mixed with an additive dispersion prepared by dispersing the colorant, the wax and the charge controlling agent in a solvent, and the resulting particles are agglomerated to a diameter equivalent to the particle diameter of the toner particles to be prepared. Then, the agglomerated particles are heated tobe fusion-bonded, whereby the toner particles are provided. By this method, the toner particles can be prepared as having a higher sphericity.

Any of the binder resins described above may be used for the emulsion polymerization/agglomeration method. Among these binder resins, the styrene resins are preferred, and the styrene copolymers are particularly preferred.

Any of the styrene monomers described above may be used as a monomer for the styrene copolymer, and any of the second monomers described above may be used as a monomer to be copolymerized with the styrene monomer.

Any of the colorants, the waxes and the charge controlling agents described above may be used for the emulsion polymerization/agglomeration method, and the colorant, the wax and the charge controlling agent may be blended in the aforesaid amounts.

In the emulsion polymerization for the preparation of the resin dispersion, for example, the monomer for the binder resin, a crosslinking agent, ion-exchanged water and an aqueous polymerization initiator are mixed in a predetermined ratio, and the polymerization is allowed to proceed at 10 to 90° C. for 1 to 24 hours with stirring at a stirring speed of 10 to 1000 rpm.

Examples of the aqueous polymerization initiator include persulfates such as potassium persulfate and ammonium persulfate, aqueous azo polymerization initiators such as 2,2′-azobis(2-amidinopropane) dihydrochloride, aqueous radical polymerization initiators such as hydrogen peroxide, and redox polymerization initiators which contain any of the aforesaid persulfates and a reducing agent such as sodium hydrogen sulfite or sodium thiosulfate in combination.

The emulsion polymerization is preferably allowed to proceed in an inert gas atmosphere (e.g., nitrogen gas atmosphere). The resin particles in the resin dispersion preferably have an average particle diameter of 0.01 to 1 μm.

On the other hand, the additive dispersion is prepared, for example, by blending the colorant, the wax and the charge controlling agent in a predetermined ratio in an aqueousmedium, optionally adding a dispersant, and dispersing and mixing these additives by dispersing means such as a ball mill.

Examples of the aqueous medium include water such as distilled water and ion-exchanged water and alcohols, which may be used either alone or in combination.

Examples of the dispersant include anionic surface active agents such as sulfates (e.g., sodium dodecylsulfate and the like), sulfonates (e.g., sodium dodecylbenzenesulfonate, sodium alkylnaphthalenesulfonate and the like), phosphates, soaps and sodium dialkylsulfosuccinate, and cationic surface active agents such as amine salts and quaternary ammonium salts (e.g., alkylbenzenemethylammonium chloride, alkyltrimethylammonium chloride, distearylammonium chloride and the like), and nonionic surface active agents such as polyethylene glycols, alkylphenolethylene oxide adducts and polyols, among which the anionic surface active agents and the cationic surface active agents are preferred. The nonionic surface active agents are each preferably used in combination with any of the anionic surface active agents and the cationic surface active agents. The aforesaid surface active agents may be used either alone or in combination.

For the agglomeration of the particles, a salt such as sodium chloride, for example, is added as an agglomeration agent to the dispersant. For the addition of the agglomeration agent, an aqueous solution ofthe dispersant is added dropwise to a dispersion mixture obtained by mixing the resin dispersion and the additive dispersion with stirring in a period of 10 minutes to 24 hours. At this time, the temperature of the dispersion mixture is preferably lower than the glass transition temperature (Tg) of the resin in the resin dispersion.

After growth of the agglomerated particles, the agglomerated particles are heated to not lower than the glass transition temperature (Tg) of the resin in the resin dispersion so as to be fusion-bonded. The fusion bonding of the agglomerated particles is carried out for about 10 minutes to about 24 hours with stirring.

The toner particles thus prepared preferably have a glass transition temperature (Tg) of 50 to 75° C., more preferably 60 to 70° C. To allow the toner particles to have a sphericity not less than 0.980, the stirring period and the temperature are properly controlled within the aforesaid ranges in the agglomerated particle growth step and the agglomerated particle fusion-bonding step.

In the pulverization method for the preparation of the toner particles, predetermined amounts of the binder resin, a release agent, the charge controlling agent and the colorant are blended and mixed by a mixer such as a Henschel mixer, and the resulting mixture is melt-kneaded by a twin screw extruder and cooled. Then, the resulting product is pulverized by a pulverizer such as a hammer mill or a jet mill. The resulting particles are classified by a classifier such as an air classifier to provide the toner particles having the predetermined average particle diameter.

The toner particles thus prepared generally have a lower sphericity than the toner particles prepared by the polymerization method and, therefore, are preferably subjected to arounding process by applying heat or a mechanical force to the toner particles.

Any of the binder resins, the charge controlling agents and the colorants described above may be used for the pulverization method, and any of the waxes described above may be used as the release agent. The colorant, the release agent (wax) and the charge controlling agent may be blended in the aforesaid amounts.

The sphericityof the toner particles is measured, for example, by means of a flow particle image analyzer (e.g., a model of FPIA-2100 available from SYSMEX CORPORATION or the like).

The sphericityof the tonerparticles is determined as an average of sphericity values measured by the flow particle image analyzer on the basis of the roundness of a two-dimensional projection image of each of the toner particles. The roundness is determined by dividing the peripheral length of a circle having the same area as the two-dimensional projection image by the peripheral length of the two-dimensional projection image.

Examples of the additive (external additive) to be bonded to the surfaces of the toner particles include titanium oxide particles and silica particles.

The average primary particle diameter of the external additive is not particularly limited, but preferably 5 to 100 nm, more preferably 8 to 30 nm. If the average primary particle diameter of the external additive is greater than the aforesaid range, the resulting nonmagnetic toner is liable to have a drastically reduced fluidity.

The average primary particle diameter of the external additive is determined, for example, by comparing an enlarged photograph of a toner particle taken by a scanning electron microscope (SEM) with a photograph of a toner particle mapped with an element contained in the external additive and taken by an element analyzer such as an X-ray spectroscopic analyzer (XMA) attached to the SEM, measuring particle diameters of 100 or more primary inorganic particles free from or adhering to the surface of the toner particle, and determining a number average of the particle diameters.

The amount of the additive (external additive) to be bonded to the surfaces of the toner particles may be properly determined depending on the particle diameters of the toner particles and the compaction degree of the toner, but is preferably 0.1 to 5 parts by weight based on 100 parts by weight of the toner particles.

A method of bonding (externally adding) the external additive to the surfaces of the toner particles is. not particularly limited, but the bonding of the external additive to the surfaces of the toner particles may be achieved, for example, by mixing the toner particles and the external additive by means of a Henschel mixer.

The apparent density of the nonmagnetic toner, i.e., the bulk density AD (hereinafter referred to simply as “loose bulk density”) of the nonmagnetic toner determined after the nonmagnetic toner is allowed to freely fall to fill a container is typically not less than 0.3 g/cm³. If the loose bulk density AD of the nonmagnetic toner is less than the aforesaid range, it is impossible to stably form a thin layer of the nonmagnetic toner on the developing roller 13 by causing the nonmagnetic toner to pass through a contact between the regulation blade 15 and the developing roller 13. The loose bulk density AD of the nonmagnetic toner is preferably not less than 0.33 g/cm³, more preferably not less than 0.35 to 0.40 g/cm^{3.}

More specifically, the loose bulk density AD (g/cm³) is determined in the following manner. The nonmagnetic toner is uniformly supplied from above into a cylindrical container having a diameter (inner diameter) of 5.03 cm, a height (inner height) of 5.03 cm and a volume of 100 cm³ through a sieve having a mesh opening of 710 μm for 20 to 30 seconds. In turn, the nonmagnetic toner supplied into the cylindrical container is leveled off along an upper face of the cylindrical container by removing an excess portion of the supplied nonmagnetic toner, and the nonmagnetic toner in the container is weighed. The loose bulk density (specific gravity) of the nonmagnetic toner is calculated based on the weight of the nonmagnetic toner thus determined.

On the other hand, the bulk density PD (hereinafter referred to simply as “compact bulk density”) of the nonmagnetic toner determined after the container filled with the nonmagnetic toner allowed to freely fall is tapped at a frequency of 1 Hz with an amplitude of 18 mm for 3 minutes is not particularly limited, but preferably not less than 0.4 to 0.7 g/cm³, more preferably not less than 0.50 to 0.60 g/cm^{3.}

More specifically, the compact bulk density PD (g/cm³) is determined in the following manner. Acylindrical member is attached onto a cylindrical container having a diameter (inner diameter) of 5.03 cm, a height (inner height) of 5.03 cm and a volume of 100 cm³, and the nonmagnetic toner is uniformly supplied from above into the cylindrical container through a sieve having a mesh opening of 710 μm. In turn, the cylindrical container is tapped at a frequency of 1 Hz with an amplitude of 18 mm for 3 minutes. After the cylindrical member is detached, the nonmagnetic toner supplied into the cylindrical container is leveled off along an upper face of the cylindrical container by removing an excess portion of the supplied nonmagnetic toner, and the nonmagnetic toner in the container is weighed. The compact bulk density (specific gravity) of the nonmagnetic toner is calculated based on the weight of the nonmagnetic toner thus determined. The tapping is achieved, for example, by means of a powder tester (e.g. a model of PT-E available from HOSOKAWAMICRON CORPORATION).

The compaction degree of the nonmagnetic toner is calculated from the aforesaid expression (i) based on the loose bulk density AD (g/cm³) and the compact bulk density PD (g/cm³) of the nonmagnetic toner.

The compaction degree of the nonmagnetic toner is not less than 0.30 and less than 0.36. By controlling the compaction degree within the aforesaid range, it is possible to maintain the fluidity of the nonmagnetic toner at a constant level and stabilize the thickness of the toner layer formed on the developing roller 13. The compaction degree of the nonmagnetic toner is more preferably 0.32 to 0.35.

The loose bulk density AD and the compact bulk density PD of the nonmagnetic toner can be controlled within the aforesaid ranges by controlling the amount and type of the external additive and the shape of the toner particles.

Referring to FIGS. 1 and 2, the size, shape and material of the casing 11 of the developing device 17 in the image forming apparatus are not particularly limited, but may be properly determined according to the specifications of the image forming apparatus.

The material for the developing roller 13 is not particularly limited, but examples thereof include a silicone rubber, aluminum and stainless steel.

The developing roller 13 is disposed in the opening of the casing 11, and the lower seal 16 to be described later is pressed against the developing roller 13. With the lower seal 16 in press contact with the developing roller 13, the unused toner is caused to pass through a contact between the developing roller 13 and the lower seal 16, while the nonmagnetic toner is prevented from leaking from the casing 11 through the contact between the developing roller 13 and the lower seal 16.

The material for the supply roller 14 is not particularly limited, but examples thereof include foamed plastic materials such as a polystyrene foam, a polyurethane foam and a polyethylene foam. The supply roller 14 has a hardness which is lower than the hardness of the developing roller 13 so that the supply roller 14 is depressed by the developing roller 13 when abutting against the developing roller 13.

The developing roller 13 is supported by a first shaft 30 (not shown in FIG. 2) so as to be rotated in a predetermined direction x in the developing process, while the supply roller 14 is supported by a second shaft 31 (not shown in FIG. 2) so as to be rotated in a predetermined direction y in the developing process. The first shaft 30 and the second shaft 31 are disposed parallel to each other. The rotation direction x of the developing roller 13 in the developing process and the rotation direction y of the supply roller 14 in the developing process are opposite to each other at a nip 32 (not shown in FIG. 2) defined between the developing roller 13 and the supply roller 14. Thus, the nonmagnetic toner passing through the nip 32 is triboelectrically charged by the developing roller 13 and the supply roller 14.

The regulation blade 15 is disposed downstream of the nip 32 with respect to the rotation direction of the developing roller 13 in the developing process, and functions to regulate the thickness of the toner layer formed on the surface of the developing roller 13. A regulation blade conventionally employed for a known image forming apparatus may be used as the regulation blade 15 without particular limitation.

The lower seal 16 is disposed along the lower edge of the opening of the casing 11 in press contact with the developing roller 13 for preventing the leakage of the nonmagnetic toner from the casing 11. In the image forming apparatus 10, 20, the lower seal 16 is inclined downward from the inside of the casing 11 toward the end of the opening. In FIGS. 1 and 2, arrows z indicate a vertical direction when the image forming apparatuses 10, 20 are actually in use.

In the image forming apparatus 10, 20, a pressure to be applied to the developing roller 13 by the lower seal 16 should be set within a proper range so as to prevent the leakage of the nonmagnetic toner from the casing 11.

The pressure tobe applied to the developing roller 13 by the lower seal 16 is preferably 5000 to 10000 N/cm². If the pressure to be applied to the developing roller 13 by the lower seal 16 is lower than the aforesaid range, the toner is liable to leak from the lower edge of the opening 12 of the casing 11 when the image forming apparatus 10, 20 shown in FIG. 1 or 2 is moved or when the rotary developing unit 21 is rotated in the image forming apparatus 20 shown in FIG. 2. On the other hand, if the pressure to be applied to the developing roller 13 by the lower seal 16 is higher than the aforesaid range, the unused toner on the developing roller 13 is liable to be stopped between the developing roller 13 and the lower seal 16 so that the passage of the toner is prevented. In this case, the toner is liable to leak from the casing 11.

The form of the image carrying means is not particularly limited. For example, the image carrying means may be the photosensitive drum 18 as shown in FIGS. 1 and 2 or a photosensitive belt.

A photosensitive material for the photosensitive drum 18 and the photosensitive belt is not particularly limited, but any of known organic photosensitive materials and inorganic photosensitive materials such as based on amorphous silicon, selenium, ZnO and CdS may be used.

In the image forming apparatus 10 shown in FIG. 1, an electrostatic latent image formed on the surface of the photosensitive drum 18 is developed into a toner image with the toner layer formed on the surface of the developing roller 13, and the toner image thus formed on the surface of the photosensitive drum 18 is transferred onto an image receiving medium (e.g., a paper sheet or the like). directly or via an intermediate transfer member (not shown).

In the image forming apparatus 20 shown in FIG. 2, nonmagnetic toners for four colors (cyan, magenta, yellow and black) are contained in the respective developing devices 27 (27C, 27M, 27Y, 27B) in the rotary developing unit 21. In the image forming apparatus 20, the rotary developing unit 21 is rotated about its rotation shaft (third shaft) 33 so that the developing rollers 13 in the developing devices 27 for the respective color toners are each brought into opposed relation to the photosensitive drum 18. Then, the developing process is performed with the use of the respective color nonmagnetic toners. Toner images of the respective color nonmagnetic toners each formed on the photosensitive drum 18 are superposed on a surface of a transfer belt (not shown) as the intermediate transfer member, and then the superposed toner images are transferred onto the image receiving medium.

Though not shown, the image forming apparatuses 10, 20 shown in FIGS. 1 and 2 each include charging means and exposing means, and optionally include cleaning means for cleaning the surface of the image carrying means (photosensitive drum) and charge removing means for removing charges from the surface of the image carrying means. Charging means, exposing means, cleaning means and charge removing means conventionally employed for a known image forming apparatus may be used without particular limitation.

### EXAMPLE

The present invention will hereinafter be described by way of examples and comparative examples. However, it should be understood that the invention be not limited to the following examples.

### Example 1

Preparation of Nonmagnetic Toner

First, 80 parts by weight of styrene, 20 parts by weight of 2-ethylhexyl methacrylate, 5 parts by weight of carbon black (available from Mitsubishi Chemical Corporation under the trade name of MA-100), 3 parts by weight of a lower molecular weight polypropylene (a polypropylene wax available from Sanyo Chemical Industries, Ltd. under the trade name of U-MEX 100TS), 2 parts by weight of a charge controlling agent (available from Orient Chemical Industries, Ltd. under the trade name of P-51) and 1 part by weight of divinylbenzene (crosslinking agent) were blended, and then the resulting mixture was sufficiently stirred by a ball mill. In turn, 2 parts by weight of 2,2′-azobis(2,4-dimethylvaleronitrile) (polymerization initiator), 400 parts-by weight of ion-exchanged water, 5 parts by weight of tricalcium phosphate (suspension stabilizer), 0.1 part by weight of sodium dodecylbenzenesulfonate were blended with the resulting mixture solution, and the resulting mixture was stirred at a rotation speed of 500 rpm for 30 minutes and further stirred at a rotation speed of 100 rpm at 70° C. in a nitrogen atmosphere for 10 hours by an emulsifying/dispersing machine (available from PRIMIX Corporation under the trade name of T.K. HOMO MIXER) for polymerization. After the polymerization, the resulting reaction solution was washed with an acid to remove calcium triphosphate, whereby a dispersion containing toner matrix particles was prepared. The toner matrix particles had a volume average particle diameter of 6.0 μm, which was measured by a particle size distribution measuring device (available from Beckman Coulter, Inc. under the trade name of Multisizer).

The toner matrix particles were filtered out of the dispersion, washed and dried, whereby toner particles were prepared. The toner particles thus prepared had a sphericity of 0.982, which was measured by a flow particle image analyzer (a model of FPIA-2100 available from SYSMEX CORPORATION).

In turn, 1.0 part by weight of hydrophobic silica (available from Cabot Corporation under the trade name of TG820F) and 0.4 parts by weight of titanium oxide (available from Fuji Titanium Industry Co., Ltd. under the trade name of TAF-510P) were blended with 100 parts by weight of the toner matrix particles, and the resulting mixture was stirred for 2 minutes by a Henschel mixer. Thus, nonmagnetic toner was prepared.

The loose bulk density AD (g/cm³) and the compact bulk density PD (g/cm³) ofthe nonmagnetic toner thus prepared were measured by means of a powder tester (a model of PT-E available from HOSOKAWAMICRON CORPORATION), and the compaction degree was calculated from the aforesaid expression (i) on the basis of the measurement values AD, PD. As a result, AD and PD were 0.381 g/cm³ and 0.556 g/cm³, respectively, and the compaction degree was 0.315.

Image Forming Process

With the use of the nonmagnetic toner prepared in Example 1 as a developing agent, an image forming process was repeated 1000 times for forming images with a printing ratio of 5% by means of the image forming apparatus 10 shown in FIG. 1. Thereafter, the image forming apparatus 10 was visually inspected for checking if the nonmagnetic toner flowed back from the contact between the developing roller 13 and the lower seal 16. The result is shown in Table 1.

The specifications of the respective components of the image forming apparatus 10 are as follows:
Developing roller 13: having an-outer diameter of φ14 mm, composed of a silicone rubber, and rotated at a rotation speed (linear speed) of 225 mm/s in the developing process.
Supply roller 14: having an outer diameter of φ14 mm, composed of a sponge (polystyrene foam), rotated at a rotation speed (linear speed) of 150 mm/s in the developing process, and having a depression depth of 1 mm with respect to the developing roller 13 at the nip.
Lower seal 16: composed of polyethylene, and pressed against the developing roller 13 with a pressure (lower-seal pressure) of 8000 N/m^{2.}
Photosensitive drum 18: rotated at a rotation speed (linear speed) of 150 mm/s in the developing process.

### Example 2

The image forming process was performed with the use of the same nonmagnetic toner as prepared in Example 1.

An image forming apparatus 10 was used, which had substantially the same specifications as in Example 1 except that the pressure applied to the developing roller 13 by the lower seal 16 was 1000 N/m^{2.}

As in Example 1, the image forming process was repeated 1000 times for forming images with a printing ratio of 5%. Thereafter, the image forming apparatus 10 was visually inspected for checking if the nonmagnetic toner flowed back from the contact between the developing roller 13 and the lower seal 16. The result is shown-in Table 1.

### Example 3

Preparation of Nonmagnetic Toner

A nonmagnetic toner was prepared by blending 1.0 part by weight of hydrophobic silica (TG820F) and 0.8 parts by weight of titanium oxide (TAF-510P) with 100 parts by weight of the same toner matrix particles as prepared in Example 1 (having a volume average particle diameter of 6.0 μcm and a sphericity of 0.982) and stirring the resulting mixture for 2 minutes by the Henschel mixer.

The nonmagnetic toner thus prepared had a loose bulk density AD of 0.372 g/cm³, a compact bulk density PD of 0.580 g/cm³, and a compaction degree of 0.359.

Image Forming Process

With the use of an image forming apparatus 10 having the same specifications as in Example 1 (with a lower-seal pressure of 8000 N/m²), the image forming process was repeated 1000 times for forming images with a printing ratio of 5%. Then, the image forming apparatus 10 was visually inspected for checking if the nonmagnetic toner flowed back from the contact between the developing roller 13 and the lower seal 16. The result is shown in Table 1.

### Comparative Example 1

Preparation of Nonmagnetic Toner

A nonmagnetic toner was prepared by blending 0.4 parts by weight of hydrophobic silica (TG820F) and 0.4 parts by weight of titanium oxide (TAF-510P) with 100 parts by weight of the same toner matrix particles as prepared in Example 1 (having a volume average particle diameter of 6.0 μm and a sphericity of 0.982) and stirring the resulting mixture for 2 minutes by the Henschel mixer.

The nonmagnetic toner thus prepared had a loose bulk density AD of 0.358 g/cm³, a compact bulk density PD of 0.599 g/cm³, and a compaction degree of 0.402.

Image Forming Process

With the use of an image forming apparatus 10 having the same specifications as in Example 1 (with a lower-seal pressure of 8000 N/m²), the image forming process was repeated 1000 times for forming images with a printing ratio of 5%. Then, the image forming apparatus 10 was visually inspected for checking if the nonmagnetic toner flowed back from the contact between the developing roller 13 and the lower seal 16. The result is shown in Table 1.

### Comparative Example 2

Preparation of Nonmagnetic Toner

A nonmagnetic toner was prepared by blending 2.0 parts by weight of hydrophobic silica (TG820F) and 1.0 part by weight of titanium oxide (TAF-510P) with 100 parts by weight of the same toner matrix particles as prepared in Example 1 (having a volume average particle diameter of 6.0 μm and a sphericity of 0.982) and stirring the resulting mixtures for 2 minutes by the Henschel mixer.

The nonmagnetic toner thus prepared had a loose bulk density AD of 0.392 g/cm³, a compact bulk density PD of 0.559 g/cm³, and a compaction degree of 0.299.

Image Forming Process

With the use of an image forming apparatus 10 having the same specifications as in Example 1 (with a lower-seal pressure of 8000 N/m²), the image forming process was repeated 1000 times for forming images with a printing ratio of 5%. Then, the image forming apparatus 10 was visually inspected for checking if the nonmagnetic toner flowed back from the contact between the developing roller 13 and the lower seal 16. The result is shown in Table 1.

### Comparative Example 3

Preparation of Nonmagnetic Toner

A nonmagnetic toner was prepared by blending 0.2 parts by weight of hydrophobic silica (TG820F) and 0.2 parts by weight of titanium oxide (TAF-510P) with 100 parts by weight of the same toner matrix particles as prepared in Example 1 (having a volume average particle diameter of 6.0 μm and a sphericity of 0.982) and stirring the resulting mixture for 2 minutes by the Henschel mixer.

The nonmagnetic toner thus prepared had a loose bulk density AD of 0.350 g/cm³, a compact bulk density PD of 0.600 g/cm³, and a compaction degree of 0.417.

Image Forming Process

With the use of an image forming apparatus 10 having the same specifications as in Example 1 (with a lower-seal pressure of 8000 N/m²), the image forming process was repeated 1000 times for forming images with a printing ratio of 5%. Then, the image forming apparatus 10 was visually inspected for checking if the nonmagnetic toner flowed back from the contact between the developing roller 13 and the lower seal 16. The result is shown in Table 1.

### Comparative Example 4

Preparation of Nonmagnetic Toner

First, 100 parts by weight of a styrene-acryl resin, 5 parts by weight of carbon black (available from Mitsubishi Chemical Corporation under the trade name of MA-100), 3 parts by weight of a lower molecular weight polypropylene (a polypropylene wax available from Sanyo Chemical Industries Ltd. under the trade name of U-MEX 100TS) and 2 parts by weight of a charge controlling agent (available from Orient Chemical Industries, Ltd. under the trade name of BONTRON N-07) were blended. Then, the resulting mixture was melt-kneaded by a twin screw extruder, and pulverized coarsely and then finely and classified. Thus, non-spherical toner matrix particles having a volume average particle diameter of 7.4 μm and a sphericity of 0.950 were prepared.

A nonmagnetic toner was prepared by blending 1.0 part by weight of hydrophobic silica (available from Cabot Corporation under the trade name of TG820F) and 0.4 parts by weight of titanium oxide (available from Fuji Titanium Industry Co., Ltd. under the trade name of TAF-510P) with 100 parts by weight of the aforesaid toner matrix particles and stirring the resulting mixture for 2 minutes by the Henschel mixer.

The nonmagnetic toner thus prepared had a loose bulk density AD of 0.372 g/cm³, a compact bulk density PD of 0.520 g/cm³, and a compaction degree of 0.285.

Image Forming Process

With the use of an image forming apparatus 10 having the same specifications as in Example 1 (with a lower-seal pressure of 8000 N/m²), the image forming process was repeated 1000 times for forming images with a printing ratio of 5%. Then, the image forming apparatus 10 was visually inspected for checking if the nonmagnetic toner flowed back from the contact between the developing roller 13 and the lower seal 16. The result is shown in Table 1.

TABLE 1

| | | | | Lower-seal | |
|---|---|---|---|---|---|
| | AD | PD | Compaction | pressure | Back flow |
| | (g/cm³) | (g/cm³) | degree | (N/m²) | of toner |
| Example 1 | 0.381 | 0.556 | 0.315 | 8000 | Not |
| | | | | | detected |
| Example 2 | 0.381 | 0.556 | 0.315 | 1000 | Not |
| | | | | | detected |
| Example 3 | 0.372 | 0.580 | 0.359 | 8000 | Not |
| | | | | | detected |
| Comparative | 0.358 | 0.599 | 0.402 | 8000 | Detected |
| Example 1 | | | | | |
| Comparative | 0.392 | 0.559 | 0.299 | 8000 | Detected |
| Example 2 | | | | | |
| Comparative | 0.350 | 0.600 | 0.417 | 8000 | Detected |
| Example 3 | | | | | |
| Comparative | 0.372 | 0.520 | 0.285 | 8000 | Detected |
| Example 4 | | | | | |

“AD” means loose bulk density, and
“PD” means compact bulk density.

In Examples 1 to 3 in which the physical property values (AD, PD and compaction degree) of the nonmagnetic toners and the pressure applied to the developing roller 13 by the lower seal 16 were set in the aforesaid predetermined ranges in the image forming apparatus shown in FIG. 1, as indicated in Table 1, the back flow of the toner from the contact between the developing roller 13 and the lower seal 16 was prevented. Example 2 in which the lower-seal pressure was set at a lower level had no practical problem, but leakage of the nonmagnetic toner from the casing 11 was observed when the image forming apparatus 10 was moved.

In Comparative Examples 1 to 4 in which the physical property values (AD, PD and compaction degree) of the nonmagnetic toners fell outside the aforesaid predetermined ranges, on the contrary, the back flow of the toner from the contact between the developing roller 13 and the lower seal 16 was observed.

While the present invention has been provided by way of illustrated embodiments thereof, it should be understood that these embodiments are merely illustrative but not limitative of the invention. Modifications of the present invention apparent to those skilled in the art are to fall within the scope of the invention defined by the following claims.

The disclosure of Japanese patent application Ser. No. 2005-317032, filed on Oct. 31, 2005, is incorporated herein by reference.

What is claimed is:

1. An image forming apparatus comprising:
developing means which includes a casing, a nonmagnetic toner filled in the casing, a developing roller disposed in an opening of the casing and supported by a first shaft so as to be rotated in one direction in a developing process, a supply roller disposed within the casing in contact with the developing roller and supported by a second shaft so as to be rotated in a direction opposite-to the direction of the rotation of the developing roller at a nip defined between the developing roller and the supply roller in the developing process, a toner layer thickness regulating member disposed downstream of the nip with respect to the direction of the rotation of the developing roller rotated in the developing process, and a lower seal disposed along a lower edge of the opening of the casing; and
image carrying means disposed in opposed relation to the developing roller of the developing means;
wherein the lower seal is inclined downward from an inside of the casing toward an end of an opening in the developing process,
wherein the nonmagnetic toner comprises toner particles having a sphericity not less than 0.98 and an additive adhering to surfaces of the toner particles, and has a bulk density AD not less than 0.3 g/cm³ as determined after the nonmagnetic toner is allowed to freely fall to fill a container, and a compaction degree not less than 0.30 and less than 0.36 as calculated from the following expression (i):
Compaction degree=(PD−AD)/PD (i)
wherein PD is a bulk density (g/cm³) of the nonmagnetic toner determined after the container filled with the nonmagnetic toner allowed to freely fall is tapped at a frequency of 1 Hz with an amplitude of 18 mm for 3 minutes.

2. An image forming apparatus as set forth in claim 1, wherein the lower seal is pressed against the developing roller with a pressure of 5000 to 10000 N/m^{2.}

3. An image forming apparatus as set forth in claim 1, wherein the toner particles of the nonmagnetic toner are particles of a styrene copolymer.

4. An image forming apparatus as set forth in claim 1, wherein the developing means includes a plurality of developing means,
the image forming apparatus further comprising a generally cylindrical rotary developing unit disposed in opposed relation to the image carrying means and supported by a third shaft,
wherein the plurality of developing means are mounted around the rotary developing unit so that the developing rollers of the plurality of developing means are each brought into opposed relation to the image carrying means when the rotary developing unit is rotated about its axis.
